(19) United States
(12) Patent Application Publication
(10) Pub. No.: US 2026/0326555 A1
(43) Pub. Date: Oct. 22, 2026

(54) METHOD AND APPARATUS FOR DISPLAYING INFORMATION ON A DISPLAY BASED ON GAZE TRACKING

(71) Applicants: HYUNDAI MOTOR COMPANY, Seoul (KR); KIA CORPORATION, Seoul (KR)

(72) Inventor: Tae Woo Kim, Hwaseong-si (KR)

(73) Assignees: HYUNDAI MOTOR COMPANY, Seoul (KR); KIA CORPORATION, Seoul (KR)

(21) Appl. No.: 19/354,271

(22) Filed: Oct. 9, 2025

(30) Foreign Application Priority Data
Apr. 16, 2025 (KR) 10-2025-0049513

(51) Int. Cl. B60K 35/235; B60K 35/22; B60K 35/231; B60K 35/28; B60K 35/29; B60R 11/04; G06T 7/73

(52) U.S. Cl. CPC B60K 35/235; B60K 35/22; B60K 35/231; B60K 35/28; B60K 35/29; B60R 11/04; G06T 7/75; B60K 2360/167; B60K 2360/172; B60K 2360/186; G06T 2207/10024; G06T 2207/10048; G06T 2207/20084; G06T 2207/30201

(57) ABSTRACT

Provided is a method for displaying information on a display based on gaze tracking. The method includes: determining important information items and presetting priorities among the important information items; receiving a facial image of a user; determining, based on the facial image of the user, a head pose, a position and a direction of a pupil, and a gaze vector; determining a display that the user is gazing at, based on one or more of among the head pose, the position and the direction of the pupil, and the gaze vector; and displaying the important information items on an identified display.

### CROSS-REFERENCE TO RELATED APPLICATION

This application claims priority to and benefits of Korean Patent Application Number 10-2025-0049513 under 35 U.S.C. § 119, filed on Apr. 16, 2025, the entire contents of which are incorporated herein by reference.

### FIELD

The present disclosure generally relates to a method and apparatus for displaying information on a display based on gaze tracking.

### BACKGROUND

The statements in this section merely provide background information related to the present disclosure and do not necessarily constitute prior art.

There are a variety of in-vehicle displays, such as instrument clusters, head-up displays (HUDs), center displays or infotainment displays, passenger displays, rear seat entertainment displays, etc. In-vehicle displays present a variety of information. The driver can get the information needed from the display. Important information items in the vehicle, such as driving-related information and warnings, may only be available on designated displays.

In addition to important information items, the display may simultaneously display various information such as gearshift user interface, air conditioning panel, etc. When various information items are displayed simultaneously, some important information items may be obscured by other items. When important information items such as speed, collision warnings, and the status of a driving assistance system are obscured by temporary pop-up messages during driving, the driver's recognition of important information items may be impaired, and safety may be compromised.

Gaze tracking technology is used to detect eye movements of a user and estimate the direction of the gaze. The gaze tracking technology utilizes devices such as cameras to analyze the position and direction of the pupil, and then uses computer vision algorithms to calculate where the user's gaze is directed.

### SUMMARY

According to at least one aspect, the present disclosure provides a method of displaying information on a display based on gaze tracking. The method includes: determining important information items and presetting priorities among the important information items; receiving a facial image of a user; determining, based on the facial image of the user, a head pose, a position and a direction of a pupil, and a gaze vector; determining a display that the user is gazing at, based on one or more of the head pose, the position and the direction of the pupil, and the gaze vector; and displaying the important information items on the determined display.

According to another aspect of the present disclosure, an apparatus for displaying information on a display based on gaze tracking is provided. The apparatus includes a memory configured to store instructions, and at least one processor. The at least one processor executing the instructions is configured to perform: determining important information items and presetting priorities among the important information items; receiving a facial image of a user; determining, based on the facial image of the user, a head pose, a position and a direction of a pupil, and a gaze vector; determining a display that the user is gazing at, based on one or more of the head pose, the position and the direction of the pupil, and the gaze vector; and displaying the important information items on an identified display.

According to another aspect of the present disclosure, a method for displaying information on a display based on gaze tracking includes: capturing a facial image of a driver to obtain video data; calculating, based on the facial image, a head pose, a pupil position and direction, and a gaze vector; identifying which display driver's gaze is directed to; displaying preset important information items on an identified display; and determining order of displaying important information items based on preset priority in case that important information items overlap on the identified display.

### BRIEF DESCRIPTION OF THE DRAWINGS

FIG. 1 is a schematic block diagram of an apparatus for displaying information on a display based on gaze tracking according to at least an embodiment of the present disclosure.

FIG. 2 is a schematic diagram of an apparatus for displaying information on a display based on gaze tracking according to at least an embodiment of the present disclosure.

FIG. 3 is a schematic diagram illustrating a landmark analysis method according to at least an embodiment of the present disclosure.

FIG. 4 is a schematic illustration of a lookup table according to at least an embodiment of the present disclosure.

FIG. 5 is a schematic diagram illustrating when information in an infotainment display is temporarily obscured according to at least an embodiment of the present disclosure.

FIG. 6 is a schematic flowchart of a method of displaying information on a display based on gaze tracking.

FIG. 7 is a schematic block diagram of an illustrative configuration of a computing device that may be used to implement the apparatuses and methods according to the present disclosure.

### DETAILED DESCRIPTION

The present disclosure is directed to providing a method and apparatus for displaying information on a display based on gaze tracking.

Specifically, the present disclosure seeks to tackle the difficulty that important information items in a vehicle, such as driving-related information and warnings, need to be viewed only on a designated display. The present disclosure also addresses the reduced driver recognition due to overlapping information items within a limited display space.

The objects of the present disclosure are not limited to those particularly described hereinabove, and the above and other objects that the present disclosure can achieve will be clearly understood by those having ordinary skill in the art from the following detailed description.

Hereinafter, some embodiments of the present disclosure is described in detail with reference to the accompanying drawings. In the following description, like reference numerals preferably designate like elements, although the elements are shown in different drawings. Further, the following description of some embodiments is omitted for the purpose of clarity and for brevity, a detailed description of related known components and functions when considered to obscure the subject of the present disclosure.

Various ordinal numbers or alpha codes, such as first, second, i), ii), a), b), etc., are prefixed solely to differentiate one component from the other but not to imply or suggest the substances, order, or sequence of the components. Throughout this specification, when a part ‘includes’ or ‘comprises’ a component, the part is meant to further include other components, to not exclude thereof unless specifically stated to the contrary. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

The following detailed description, along with the accompanying drawings, is intended to illustrate example embodiments of the present disclosure and is not intended to represent the only embodiments in which the disclosure may be practiced.

Herein, the term ‘image’ may be used interchangeably with ‘video’. In a technical context, video and images are distinct concepts, but in the field of computer vision, the terms are sometimes used interchangeably in certain contexts.

The term ‘information’ as used herein refers to any information items provided by the vehicle, such as speed, RPM, lane departure warnings, gearshift user interface, etc. As used herein, the term ‘important information items’ refers to information items that are set to appear on the display that the user is gazing at.

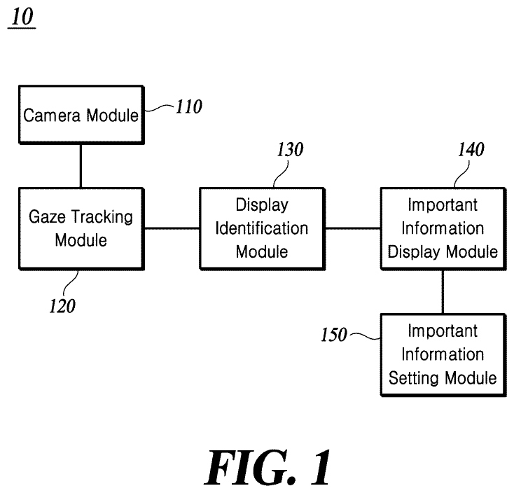

FIG. 1 is a schematic block diagram of an apparatus for displaying information on a display based on gaze tracking, according to at least an embodiment of the present disclosure.

An apparatus for displaying information on a display based on gaze tracking (referred to as a ‘gaze-based information display apparatus’ hereinafter) displays information on the display based on the user's gaze tracking results. For example, the gaze-based information display apparatus 10 may display preset important information items on the display that the user is gazing at among multiple displays in the vehicle.

Referring to FIG. 1, the gaze-based information display apparatus 10 may include a camera module 110, a gaze tracking module 120, a display identification module 130, an important information display module 140, and an important information setting module 150.

The camera module 110 may obtain video data by photographing the driver's face. The gaze tracking module 120 may calculate, from the video data, head pose estimation, pupil position and direction analysis, and gaze vector. The display identification module 130 may identify the display that the user is gazing at. The important information display module 140 may display preset important information items on the display that the user is gazing at. The important information setting module 150 may set important information items according to the convenience of the user, with all information provided by the vehicle. Not all blocks illustrated in FIG. 1 are requisite components, and some blocks included in other embodiments may be added, changed, or deleted. The components illustrated in FIG. 1 are shown as functionally distinct elements, and at least one or more of the components may be implemented in an integrated manner in an actual physical environment.

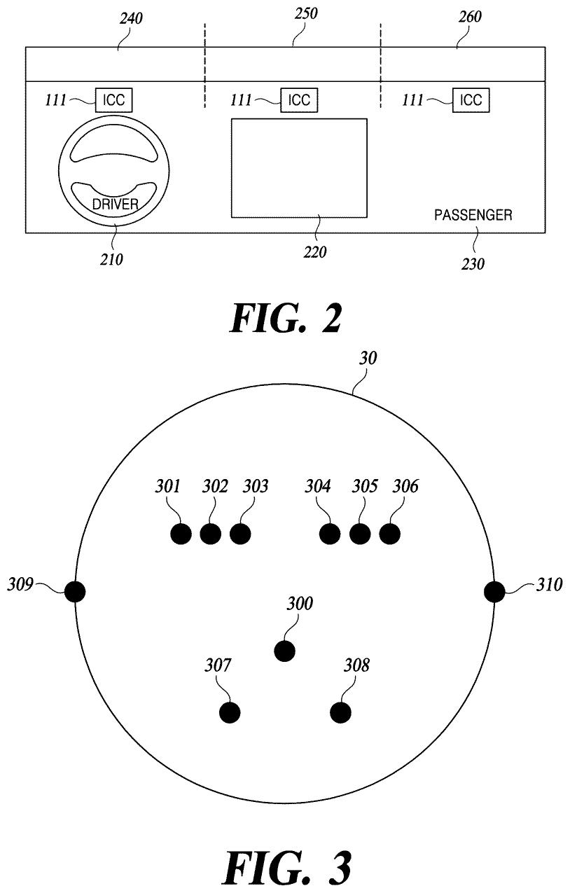

FIG. 2 is a schematic diagram of the gaze-based information display apparatus 10 according to at least an embodiment of the present disclosure.

The following details the respective components of the gaze-based information display apparatus 10 with reference to FIG. 1 and FIG. 2.

The camera module 110, according to at least an embodiment of the present disclosure, includes one or more cameras. The camera module 110 may transmit video data obtained by the cameras to the gaze tracking module 120. The camera module 110 may be made of a combination of hardware and software for pre-processing the obtained video data.

A camera (or cameras) 111 may be installed (or mounted) inside a vehicle. Referring to FIG. 2, the camera 111 may be installed at a location that captures the driver's upper torso or face, such as at a steering wheel 210, an infotainment display 220, and a front dashboard 230 of the passenger seat, etc.

To perform machine learning based face detection or gaze tracking, the camera 111 may be an RGB camera or an infrared (IR) camera. The RGB camera may capture images in the visible light region, allowing for high-resolution face detection. Poorly lit environments may degrade the face detection performance of the RGB camera. For example, driving at night or in environments under backlight may result in reduced face detection performance of the RGB camera. Reduced face detection performance of the RGB camera may result in less accurate gaze tracking. To compensate for poorly lit environments, the infrared (IR) camera may be used for the camera 111. The infrared (IR) camera may detect faces in environments, even in the absence of visible light. According to at least an embodiment of the present disclosure, one may select (or autonomously select) between an RGB camera and an infrared camera for use as the camera 111, depending on the driving environment of the vehicle and the accuracy of gaze tracking.

The camera 111 may obtain an image including the driver's face in real time. The camera module 110 may set the resolution and format of the captured image to meet the requirements of the gaze tracking module 120. For example, to maintain a particular resolution or frame rate required by the gaze tracking module 120, noise removal, brightness adjustment, image resizing, and the like may be performed.

The camera module 110 may transmit video data captured by the camera 111 to the gaze tracking module 120. The transmission of the video data may be done by wire or wirelessly. In the wired scheme, the camera may be electrically connected to the gaze tracking module 120 by using a MIPI CSI (camera serial interface) or a USB interface. In the wireless scheme, data may be transmitted by using Wi-Fi or an in-vehicle Controller Area Network (CAN) or Ethernet. However, it is merely an example, and the wired and wireless connections are not limited thereto. The gaze tracking module 120 may use the video data transmitted from the camera module 110 as input data for face detection and landmark analysis.

The gaze tracking module 120 may calculate a gaze vector by performing, based on the driver's face image, face detection, landmark analysis, head pose estimation, and pupil's position and direction analysis.

The face detection may identify the driver's face from the face image and may detect its eye region. The face detection may be performed by using, for example, the MediaPipe face detection algorithm. The face detection may determine the position and size of the face in the image. For example, the MediaPipe face detection algorithm may mark a rectangular region containing a face in an image with a bounding box and calculate the size and position of the face, the direction of the face, etc. The face detection may be a well-known technique in the field of computer vision, so a detailed description thereof will be omitted.

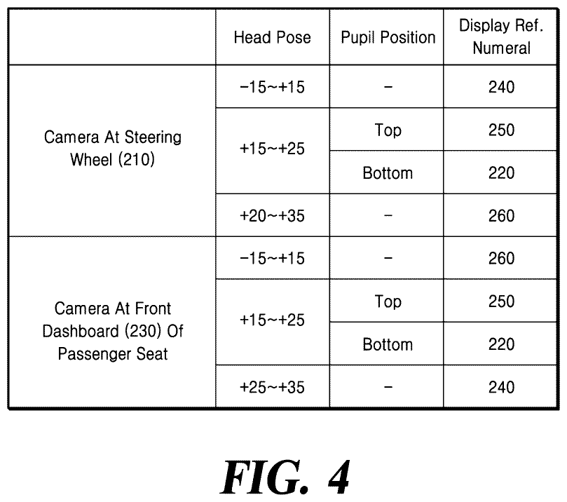

FIG. 3 is a schematic diagram illustrating a landmark analysis method according to at least an embodiment of the present disclosure.

The gaze tracking module 120 may detect landmarks by using the MediaPipe face mesh model, which is a lightweight deep learning-based model provided as open source by Google. The MediaPipe face mesh model may be capable of detecting approximately 468 fixed facial points in 3D space. The landmark analysis may extract coordinates of major feature points within the face, such as eyes, nose, mouth, ears, etc. The accuracy of gaze tracking is enhanced by the detection of more landmarks. Landmark point coordinates may be calculated as 2D or 3D coordinate values. FIG. 3 shows a large circle 30 that is a schematic representation of a human face. The face may be recognized by designating specific points of the face within the large circle 30. For example, recognized respectively as landmarks of the face may be a nose 300, a left eye's left end 301, a left pupil 302, a left eye's right end 303, a right eye's left end 304, a right pupil 305, a right eye's right end 306, a lip's left end 307, a lip's right end 308, a left ear 309, and a right ear 310.

For example, an attention mesh model may increase the accuracy of the gaze direction analysis of the face. The attention mesh model may include additional landmarks around the pupil to improve the accuracy of the gaze direction analysis of the face. By densely placing landmarks around the eyes, the eye area may be precisely detected, and the accuracy of the gaze direction analysis can be improved.

A gaze tracking module 120 may estimate the head pose of a face using a machine learning-based PnP (Perspective-n-Point) network or a deep learning-based HeadPoseNet model. The head pose analysis may use the landmarks on the face as a basis for calculating the position of the nose and ears to estimate the head pose of the face. The head pose analysis may indicate where the face is directed. For example, the head pose analysis may distinguish whether the driver is looking straight ahead or has turned the face to the left or right sides. For example, the position of the left ear 309 or right ear 310 and the nose 300 may be combined to estimate whether the face is directed to the left or right sides.

By analyzing the relative positions of the obtained landmark around the pupil, the direction of movement of the pupil may be determined. For example, based on changes in the relative distance between the obtained landmarks around the pupil, whether the eye is looking to the left side, looking to the right side, or looking straight ahead may be determined. For example, if the distance between the left pupil 302 and the left eye's left end 301 is greater than the distance between the left pupil 302 and the left eye's right end 303, the direction of the pupil may be determined to be the left side. For example, if the distance between the left pupil 302 and the left eye's left end 301 is less than the distance between the left pupil 302 and the left eye's right end 303, the direction of the pupil may be determined to be the right side.

The gaze tracking module 120 may provide information on the driver's head pose, pupil position and direction, and gaze vector to the display identification module 130. The gaze tracking module 120 may calculate the gaze vector based on detected facial landmarks using a deep learning-based model. For example, the deep learning-based model for gaze vector estimation may be a convolutional neural network (CNN) based gaze estimation model such as the Light-weight Gaze Regression Network or GazeNet. The gaze tracking module 120 may provide information on the driver's head pose, pupil position and direction, and gaze vector to the display identification module 130. The gaze vector may refer to the direction of the driver's gaze in three-dimensional space based on the head pose, pupil position and direction. The process for calculating the gaze vector is well known in the art of computer vision and will not be described in detail.

The display identification module 130 may identify the display that the user i gazing at, based on the head pose, the pupil position and direction, and the gaze vector transmitted from the gaze tracking module 120. For example, referring to FIG. 2, if the driver's gaze is directed toward a head-up display's (HUD's) center portion 250, the HUD's center portion 250 may be determined to be the display that the user is gazing at. For example, if the vehicle is linked with a smartphone, the display identification module 130 may identify the smartphone screen as the display that the user is gazing at.

The display identification module 130 may perform a display identification based on whether the gaze vector is directed at a particular display. For example, referring to FIG. 2, the display identification module 130 may store in advance the 3D coordinates of in-vehicle displays at 220, 240, 250, and 260, and the display identification module 130 may identify the display to which the gaze vector is most closely directed. For example, a display may be identified when the gaze vector is within a certain angle relative to the center of the display. For example, since the driver's gaze may be momentarily shaky, the final display identification may be made when the driver's gaze is fixed on a particular display for a certain amount of time.

The display identification module 130 may identify the display by using a look-up table-based matching method.

FIG. 4 is a schematic illustration of a lookup table according to at least an embodiment of the present disclosure. The lookup table may define a display to be identified based the head pose and the pupil position, according to a camera position. The lookup table may categorize the pupil position as top or bottom.

For example, upon recognizing the driver's face based on the camera at the steering wheel 210, the driver's gaze may be determined to be directed to the HUD's left portion 240 when the head pose is between about −15 degrees and about +15 degrees and the pupil position is neutral. For example, upon recognizing the driver's face based on the camera at the front dashboard 230 of the passenger seat, the driver's gaze may be determined to be directed to the HUD's center portion 250 when the head pose is between about +25 degrees and about +35 degrees and the pupil is at the top position.

If the driver's face is directed forward and only the pupil is moving, the display identification may be difficult to achieve by using only the look-up table according to embodiments of the present disclosure. Therefore, the display identification module 130, according to at least an embodiment of the present disclosure, may be implemented along with a method that directly utilizes the gaze vector.

Once the display identification module 130 identifies the display that the use is gazing at, the important information display module 140 may display preset important information items on the identified display. For example, when the driver's gaze is directed to the HUD's center portion 250, the important information display module 140 may display the preset important information items on the HUD's center portion 250.

Important information items, according to at least an embodiment of the present disclosure, may include vehicle speed, collision warnings, driving assistance system status, fuel level, RPM, engine warnings, lane departure warnings, and the like. The important information items may be preset by the user through the important information setting module 150.

The important information setting module 150 may prioritize the important information items according to the convenience of the user. The important information items may be set to be displayed, based on the priority set by the user, ahead of information that is steadily displayed on a designated display or ahead of pop-up information. For example, important information items that presently appear when the user's gaze is directed to a particular display may be overlapped an information item that appears on that particular display. The user (or driver) may set a prioritization between the overlapping information items to determine the output order of the information items shown on the display.

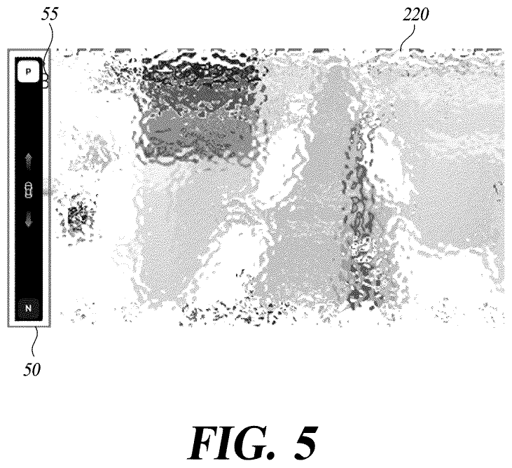

FIG. 5 is a schematic diagram illustrating when information in an infotainment display is temporarily obscured according to at least an embodiment of the present disclosure.

According to applicable laws and regulations, information items such as in-vehicle speed information and warning signs should be prioritized for the driver. When the important information setting module 150 sets the priority of important information items, it is possible to prevent important information items in the instrument cluster from being temporarily obscured. For example, referring to FIG. 5, the vehicle speed information at 55 may be temporarily obscured by a gearshift user interface 50. Setting the vehicle speed information 55 as an important information item with a higher priority than the gearshift user interface 50 may prevent the speed information 55 from being obscured. For example, when important information items in the instrument cluster are temporarily obscured by pop-up information, the present disclosure will prioritize displaying on the display screen the high-priority important information items. For example, when important information items in the instrument cluster are temporarily obscured by a climate control panel, the present disclosure may prioritize the display of high-priority important information items on the display screen.

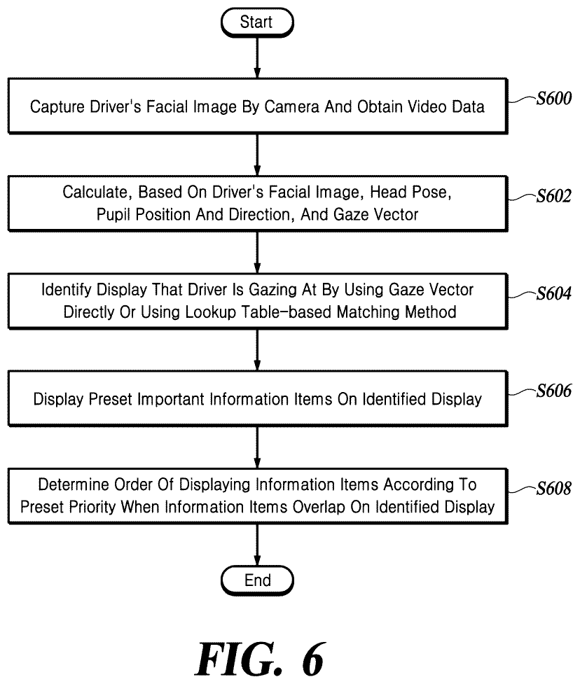

FIG. 6 is a schematic flowchart of a method of displaying information on a display based on gaze tracking.

The camera (or cameras) 111 of the camera module 110 may be installed (or mounted) inside a vehicle. Referring to FIG. 2, the camera (or cameras) 111 may be installed in positions to capture a video of the driver's upper torso or face. The camera (or cameras) 111 may obtain the video, including the driver's face, in real time. The camera module 110 may set the resolution and format of the captured images to meet the requirements of the gaze tracking module 120. The camera module 110 may transmit the video data captured by the camera (or cameras) 111 to the gaze tracking module 120 (S600).

The gaze tracking module 120 may calculate, using the transmitted video data from the camera module 110, a gaze vector based on face detection, landmark analysis, head pose inference, and pupil position and direction analysis (S602).

The display identification module 130 may identify where the driver's gaze is directed to, based on information on the head pose, pupil position and direction, and gaze vector received from the gaze tracking module 120. The display identification module 130 may perform the display identification based on whether the gaze vector is directed to a particular display. Furthermore, the display identification module 130 may identify the display by using a lookup table-based matching method (S604).

The important information display module 140 may display preset important information items on the display that the user (or driver) is gazing at. For example, when the driver's gaze is directed toward the HUD's center portion 250, the driver's preset important information items are displayed in the HUD's center portion 250 (S606).

When important information items are overlapping on the display that the user is gazing at, the important information setting module 150 may set a priority among the information items shown on the display. The set prioritization may determine the order of displaying information items on the display (S608). For example, the vehicle speed information 55 may be temporarily obscured by the gearshift user interface 50. Setting the vehicle speed information 55 as an important information item with a higher priority than the gearshift user interface 50 may prevent the speed information 55 from being obscured.

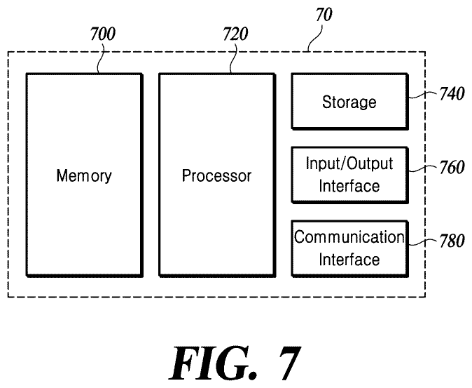

FIG. 7 is a schematic block diagram of an illustrative configuration of a computing device 70 that is used to implement the methods or apparatuses according to the present disclosure.

The computing device 70 may include some or all of a memory 700, a processor 720, a storage 740, an input/output interface 760, and a communication interface 780. The computing device 70 may be a stationary computing device, such as a desktop computer, server, or the like, as well as a mobile computing device, such as a laptop computer, smartphone, or the like. The computing device 70 may include any specialized hardware accelerator capable of efficiently processing computations on an artificial intelligence model. For example, the computing device 70 may include a graphics processing unit (GPU), a tensor processing unit (TPU), or a neural processing unit (NPU).

The memory 700 may store programs that cause (or operate) the processor 720 to perform methods or operations under various embodiments of the present disclosure. For example, the program may include a plurality of instructions executable by the processor 720, and the plurality of instructions may be executed by the processor 720 to perform the methods or operations described above. The memory 700 may be a single memory or a plurality of memories. In this case, the information required to perform the methods or operations according to various embodiments of the disclosure may be stored in a single memory or stored divisively among the plurality of memories. When the memory 700 is composed of a plurality of memories, they may be physically separated. The memory 700 may include at least one of volatile memory and non-volatile memory. The volatile memory may include static random access memory (SRAM) or dynamic random access memory (DRAM), for example, and the non-volatile memory may include flash memory, for example.

The processor 720 may include at least one core capable of executing at least one set of instructions. The processor 720 may execute instructions stored in the memory 700. The processor 720 may be a single processor or a plurality of processors.

The storage 740 may maintain stored data even when power to the computing device 70 is interrupted. For example, the storage 740 may include non-volatile memory or may include a storage medium such as magnetic tape, optical disk, or magnetic disk. Programs stored in the storage 740 may be loaded into the memory 700 before execution by the processor 720. The storage 740 may store files written in a programming language, and programs generated by a compiler or the like may be loaded from the files into the memory 700. The storage 740 may store data to be processed by the processor 720 and/or data that has been processed by the processor 720.

The input/output interface 760 may provide an interface with an input device, such as a keyboard, mouse, etc., and/or with an output device, such as a display device, printer, etc. A user may trigger the execution of a program by the processor 720 via the input device and/or view the results of processing by the processor 720 via the output device.

The communication interface 780 may provide access to an external network. The computing device 70 may communicate with other devices via the communication interface 780.

The components described in the example embodiments of the present disclosure may be achieved by hardware components including at least one of Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the steps described in the example embodiments of the present disclosure may be achieved by software that may be recorded on a recording medium. At least some of the components, functions, and steps described in the example embodiments of the present disclosure may be achieved by a combination of hardware and software.

The method according to example embodiments of the present disclosure may be written as a program that can be executed in a computer and may be implemented using various recording media, such as magnetic storage media, optical readout media, digital storage media, etc.

Implementations of the various techniques described herein may be implemented as digital electronic circuitry, or as computer hardware, firmware, software, or combinations thereof. Implementations may be implemented as computer program products, i.e., computer programs tangibly embodied in an information carrier, e.g., a machine-readable storage device (computer-readable medium), or a radio signal, for processing by, or controlling the operation of, a data processing device, e.g., a programmable processor, a computer, or a plurality of computers. A computer program, such as the computer program(s) described above, may be written in any form of programming language, including compiled or interpreted languages and may be deployed in any form, including as a stand-alone program or as modules, components, subroutines, or other units suitable for use in a computing environment. The computer program may be deployed to be processed on a computer or computers at a single site, or distributed across multiple sites and interconnected by a communication network.

Processors suitable for processing computer programs include, for example, both general-purpose and special-purpose microprocessors, and any one or more processors of any type of digital computer. Generally, the processor will receive instructions and data from read-only memory or random access memory, or both. Elements of the computer may include at least one processor executing instructions and one or more memory devices storing instructions and data. In general, the computer may include one or more mass storage devices, such as magnetic, magneto-optical, or optical disks, that store data, or may be coupled to receive data from them, transmit data to them, or both. Information carriers suitable for embodying computer program instructions and data include, for example, semiconductor memory devices, e.g., hard disks, magnetic media such as floppy disks and magnetic tapes, optical media such as compact disk read only memory (CD-ROM) and digital video disks (DVDs), magneto-optical media such as floptical disks, read only memory (ROM), random access memory (RAM), flash memory, erasable programmable ROM (EPROM), electrically erasable programmable ROM (EEPROM), and the like. The processor and memory may be supplemented by or include special-purpose logic circuitry.

The processor may perform an operating system and software applications executed on the operating system. The processor device may also access, store, manipulate, process, and generate data in response to the execution of the software. For ease of understanding, a processor device is sometimes described as utilizing a single processing element, but one of ordinary skill in the art will recognize that a processor device may include a plurality of processing elements and/or a plurality of types of processing elements. For example, a processor device may include a plurality of processors or one processor and one controller. Other processing configurations, such as a parallel processor, can be used.

Further, the non-transitory computer-readable media may be any available medium that can be accessed by a computer and may include both computer storage media and transmission media.

While this specification includes details of some specific implementations, they should not be understood as limiting the scope of any invention or claimed subject matter, but rather as a description of features that may be peculiar to a particular embodiment of a particular invention. Certain features described herein in the context of individual embodiments may be implemented in combination in a single embodiment. Conversely, various features described in the context of a single embodiment may also be implemented in a plurality of embodiments, either individually or in any suitable sub-combination. Further, while features may operate in a particular combination and be initially described literally as claimed, one or more features of the claimed combination may be excluded from the claimed combination in some instances, and the claimed combination may be changed to a sub-combination or variation of the sub-combination.

Similarly, although the drawings depict operations in a particular order, it should not be understood that such operations must be performed in the particular or sequential order depicted or that all depicted operations must be performed to achieve a desired result. In certain cases, multitasking and parallel processing may be advantageous. Further, the separation of the various device components in the embodiments described above should not be understood to require such separation in all embodiments, and it should be understood that the program components and devices described may generally be integrated into a single software product or packaged in multiple software products.

According to at least an embodiment of the present disclosure, the driver can view important information items in the vehicle, such as driving-related information and warnings, from the display that the user is gazing at rather than from a designated display.

According to at least an embodiment of the present disclosure, where multiple information items are overlapped within a limited display space, the information items outputted to the screen can be prioritized.

The effects of the present disclosure are not limited to those mentioned above, and other effects not mentioned will be apparent to those of ordinary skill in the art from the above description.

On the other hand, the embodiments of the present disclosure presented by the specification and drawings are merely specific examples for clarity and are not intended to limit the scope of the disclosure. It should be clear to those of ordinary skill in the art that, besides the embodiments disclosed herein, modifications thereto can be made within the scope of the present disclosure.

The scope of protection of the present disclosure is to be construed by the following claims, and all equivalent technical ideas within the scope thereof are to be construed as being included in the scope of the present disclosure.

What is claimed is:

1. A method comprising:
determining important information items and presetting priorities among the important information items;
receiving a facial image of a user;
determining, based on the facial image of the user, a head pose, a position and a direction of a pupil, and a gaze vector;
determining a display that the user is gazing at based on one or more of the head pose, the position and the direction of the pupil, and the gaze vector; and
displaying the important information items on the determined display.

2. The method of claim 1, wherein receiving the facial image of the user comprises:
photographing by at least one RGB camera or at least one infrared camera.

3. The method of claim 1, further comprising:
determining the head pose by calculating a position of a nose and an ear based on landmarks on a face of the user.

4. The method of claim 1, further comprising:
determining the position and the direction of the pupil by analyzing relative positions of landmarks around an eye of the user.

5. The method of claim 1, wherein determining of the display comprises:
determining that a gaze of the user is directed toward the display based on the gaze vector which is located within a certain angle relative to a center of the display.

6. The method of claim 1, wherein determining the display comprises:
identifying the display by using a lookup table-based matching method that is based on a camera position, the head pose, and the position of the pupil.

7. An apparatus comprising:
a memory configured to store instructions; and
at least one processor configured to execute the instructions to perform:
determining important information items and presetting priorities among the important information items;
receiving a facial image of a user;
determining, based on the facial image of the user, a head pose, a position and a direction of a pupil, and a gaze vector;
determining a display that the user is gazing at based on one or more of the head pose, the position and the direction of the pupil, and the gaze vector; and
displaying the important information items on the determined display.

8. The apparatus of claim 7, wherein the receiving of the facial image of the user is accomplished by
photographing by at least one RGB camera or at least one infrared camera.

9. The apparatus of claim 7, further comprising:
determining the head pose by calculating a position of a nose and an ear based on landmarks on a face of the user.

10. The apparatus of claim 7, further comprising:
determining the position and the direction of the pupil by analyzing relative positions of landmarks around an eye of the user.

11. The apparatus of claim 7, wherein the determining of the display is accomplished by
determining that a gaze of the user is directed toward the display based on the gaze vector which is located within a certain angle relative to a center of the display.

12. The apparatus of claim 7, wherein the determining of the display is accomplished by identifying the display by using a lookup table-based matching method that is based on a camera position, the head pose, and the position of the pupil.

13. A method of displaying information on a display based on gaze tracking, the method comprising:
capturing a facial image of a driver to obtain video data;
calculating, based on the facial image, a head pose, a pupil position and direction, and a gaze vector;
identifying which display driver's gaze is directed to;
displaying preset important information items on an identified display; and
determining order of displaying important information items based on preset priority in case that important information items overlap on the identified display.

14. The method of claim 13, wherein capturing the facial image is accomplished by at least one RGB camera or at least one infrared camera.

15. The method of claim 13, wherein calculating the head nose is accomplished by calculating a position of a nose and an ear based on landmarks on the driver's facial image.

16. The method of claim 13, wherein calculating the pupil position and direction is accomplished by analyzing relative positions of landmarks around an eye of a driver of the driver's facial image.

17. The method of claim 13, wherein identifying which display driver's gaze is accomplished by determining that a gaze of a driver is directed toward a display based on the gaze vector which is located within a certain angle relative to a center of the display.

18. The method of claim 13, wherein identifying which display driver's gaze is accomplished by identifying a display by using a lookup table-based matching method that is based on a camera position, the head pose, and the pupil position and direction.

19. The method of claim 13, wherein calculating the gaze vector is accomplished by using a deep learning-based model.

20. The method of claim 13, further comprising:
displaying the important information items on the identified display.
